(19) United States
(12) Patent Application Publication
(10) Pub. No.: US 2007/0062381 A1
(43) Pub. Date: Mar. 22, 2007

(54) High production nutcracking apparatus having pivotally mounted protective hood

(75) Inventors: James B. Quantz, Lexington, SC (US); Pascal W. Pitts, Cayce, SC (US); John L. Feaster, Columbia, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Machine Design Incorporated

(21) Appl. No.: 11/231,138

(22) Filed: Sep. 20, 2005

(51) Int. Cl. A23N 5/00

(52) U.S. Cl. 99/568

(57) ABSTRACT

A high production nutcracking apparatus having a hood pivotally mounted to the machine frame to protectively cover the operating components, and so that the hood is pivotable between a closed position and a raised or open position which gives the operator of the machine access to the interior components. The hood is raised by a computer controlled pneumatic cylinder which is programmed to protect the operator from the risk of the hood falling from the raised or open position to the closed position.

### BACKGROUND OF THE INVENTION

The present invention relates to a high speed nutcracking apparatus having a pivotally mounted hood for protectively covering the operating components of the machine.

U.S. Pat. Nos. 4,332,827; 5,623,867; 6,205,915; 6,270,824; 6,584,890, 6,588,328; and 6,772,680 all disclose a high speed nutcracking apparatus which includes a rotatable turret which mounts a plurality of cracking units arranged about its periphery, with each cracking unit having an opening adapted to receive an individual nut from a feed conveyor which comprises a plurality of nut transport elements mounted in succession on a feed chain. Each of the nut transport elements includes an upwardly open traverse receptacle for holding an individual nut, and each cracking unit on the turret has an anvil which is moved axially into the receptacle at a pick up point so that the nut is engaged between the anvil and a crack die on the other side of the opening.

In operation, the feed conveyor moves tangentially past the rotating turret so that the anvils of the cracking units enter the receptacles of respective nut transport elements at the pick up point and engage and pick up the nut. After the cracking unit and engaged nut have moved away from the pick up point and reach a cracking location, the crack die of the cracking unit is impacted by a shuttle so that the crack die applies an impact to the nut to crack the shell.

To protectively cover the rotating turret, it has been conventional to pivotally mount a hood along the upper rear edge of the frame of the apparatus, and so that the hood is pivotable between a closed position covering the turret and a raised or open position which gives the operator of the machine access to the interior components for maintenance and cleaning. In order to provide adequate protection from the rapidly rotating turret, the hood has heretofore been fabricated from a sheet metal material such as stainless steel. This in turn results in the hood having significant weight, and it has been difficult for the operator to lift and lower the hood.

It is accordingly an object of the present invention to provide a nutcracking apparatus of the described type which includes a pneumatic system for lifting and lowering the hood, while avoiding the risk of injury to the operator.

### SUMMARY OF THE INVENTION

The above and other objects and advantages of the invention are achieved by the provision of a high production nutcracking apparatus of the described type which includes a pneumatic system for selectively pivoting the hood between the open and closed positions, and which includes a pneumatic cylinder connected between the machine frame and the hood. A first port is provided in the pneumatic cylinder on one side of the piston and a second port is provided on the other side of the piston. Also, a first adjustable bleed valve is connected at the first port, and a second adjustable bleed valve is connected at the second port. A control valve means is provided for selectively introducing pressurized air into a first air line which leads to the first port via the first bleed valve, or into a second air line which leads to the second port via the second bleed valve.

In operation, pressurized air can be delivered to the first port through the first air line while venting the cylinder through the second line and the second bleed valve, or air can be delivered to the second port through the second air line while venting the cylinder through the first air line and the first bleed valve.

The above construction permits the hood to be both opened and closed in a controlled and thus safe manner.

As a further aspect of the invention, a computer controller is provided which is programmed so as to control the operation of the pneumatic pivoting system to insure that the pneumatic system operates in a safe manner. Specifically, the computer controller can be programmed to operate the system to guard against an injury to the operator during the closing operation. For example, with the hood open and upon the hood close switch being pressed, the computer can be programmed to momentarily energize a control valve to insure that the pneumatic cylinder is charged with air tending to open the hood, before air is delivered to the side of the piston for closing the hood. This action avoids the possibility of the hood rapidly falling to the closed position in the event that the hood has been manually opened and there is no significant charge of air on the hood opening side of the piston while the hood is in the open position.

The computer controller can also be programmed to reduce the likelihood that the operator's hand could be caught in the “pinch point” provided along the front edge of machine frame. For this purpose, the computer controller may be programmed to terminate the delivery of pressurized air to the closing side of the piston after the hood has been moved to a midpoint of its travel to the closed position, so that continued movement results solely from gravity. The relevant bleed valve prevents the rapid evacuation of the cylinder and thus the hood continues its closing movement at a controlled rate. Also, the absence of pressurized air on the closing side of the piston avoids the possibility that the forward edge of the hood could be forcefully pressed against a hand of the operator which might be inadvertently placed in the “pinch point”.

### BRIEF DESCRIPTION OF THE DRAWINGS

Having thus described the invention in general terms, reference will now be made to the accompanying drawings, which are not necessarily drawn to scale, and wherein:

FIG. 1 is a perspective view of a high production nutcracking apparatus which embodies the features of the present invention;

FIG. 2 is a sectional side elevation view of the apparatus taken along the line 2-2 of FIG. 1;

FIG. 3A is a fragmentary sectional side elevation view corresponding to FIG. 2 and showing the hood lifting sequence;

FIG. 3B is a view similar to FIG. 3A and showing the hood closing sequence;

FIG. 3C is a view similar to FIG. 3A and showing the hood in the fully closed position; and

FIG. 4 is a fragmentary sectional view of the bleed valve at the upper end of the pneumatic cylinder of the apparatus of the invention.

### DETAILED DESCRIPTION OF THE PREFERRED EMBODIMENT

The present invention now will be described more fully hereinafter with reference to the accompanying drawings, in which a preferred, but not necessarily all embodiments of the invention is shown. Indeed, the invention may be embodied in many different forms and should not be construed as limited to the embodiment set forth herein. Rather, the illustrated embodiment is provided so that this disclosure will satisfy applicable legal requirements. Like numbers refer to like elements throughout.

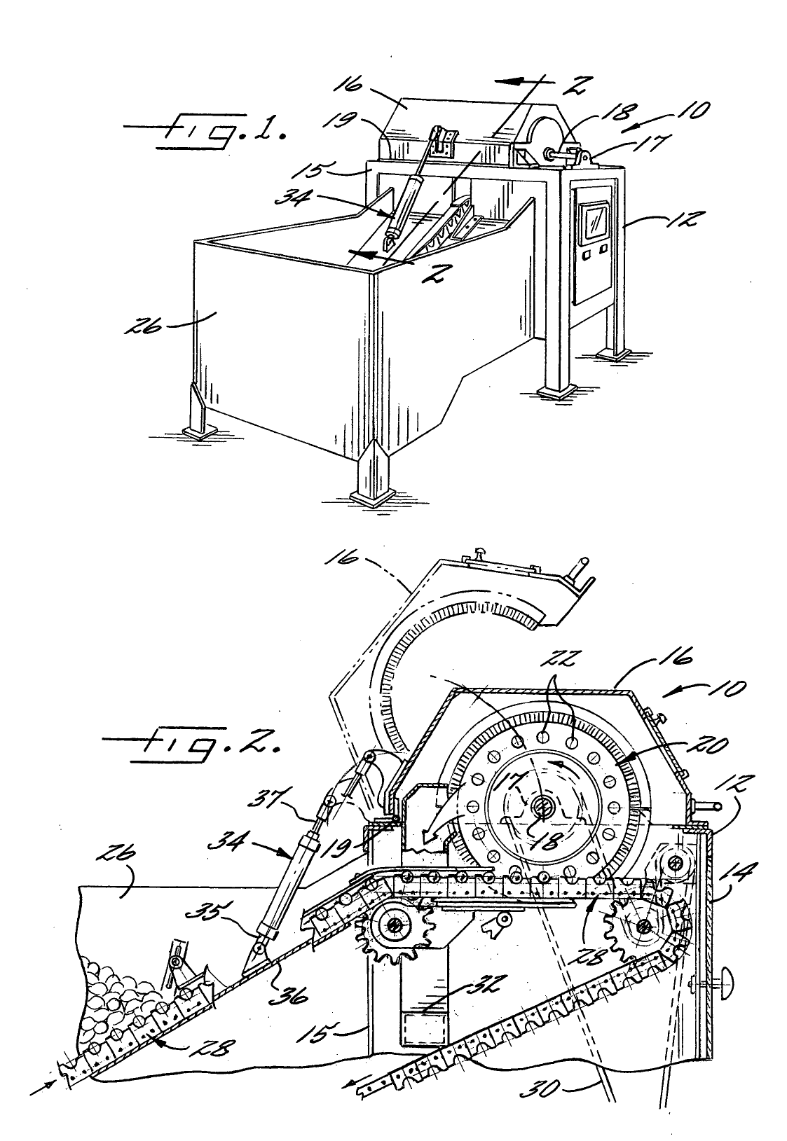

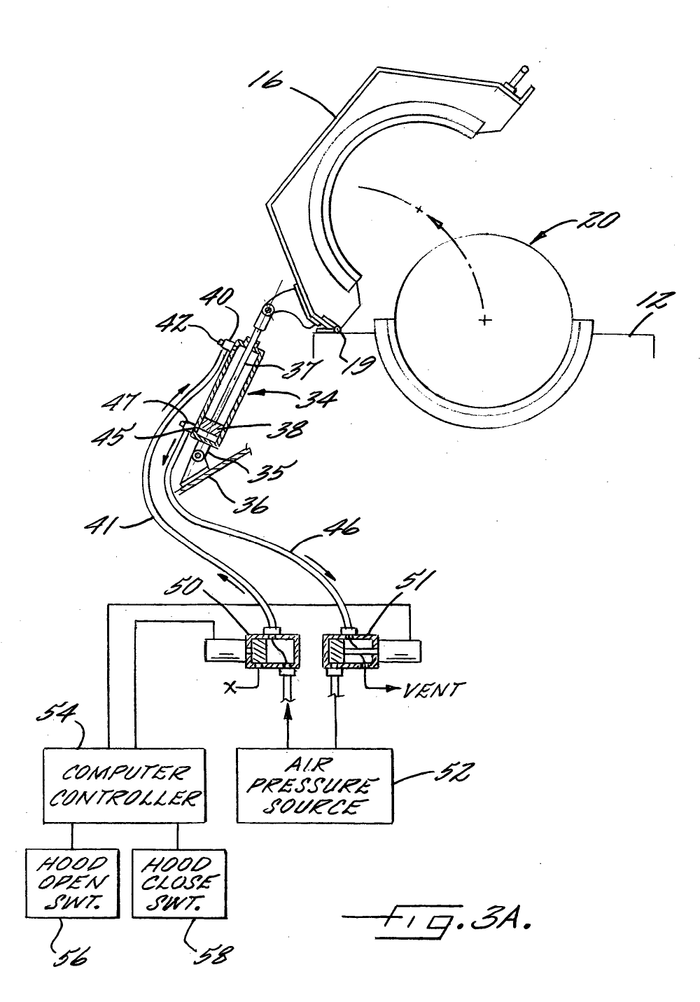

Referring more particularly to the drawings, FIGS. 1-2 illustrate a high production nutcracking apparatus 10 which embodies the features of the present invention. As will become apparent, many of the components of the present apparatus conform to the corresponding components of the apparatus shown and described in the prior U.S. patents which are listed above under the heading Background of the Invention. The disclosures of these prior patents are expressly incorporated herein, and reference may be had to these prior patents for a more detailed description of the common components.

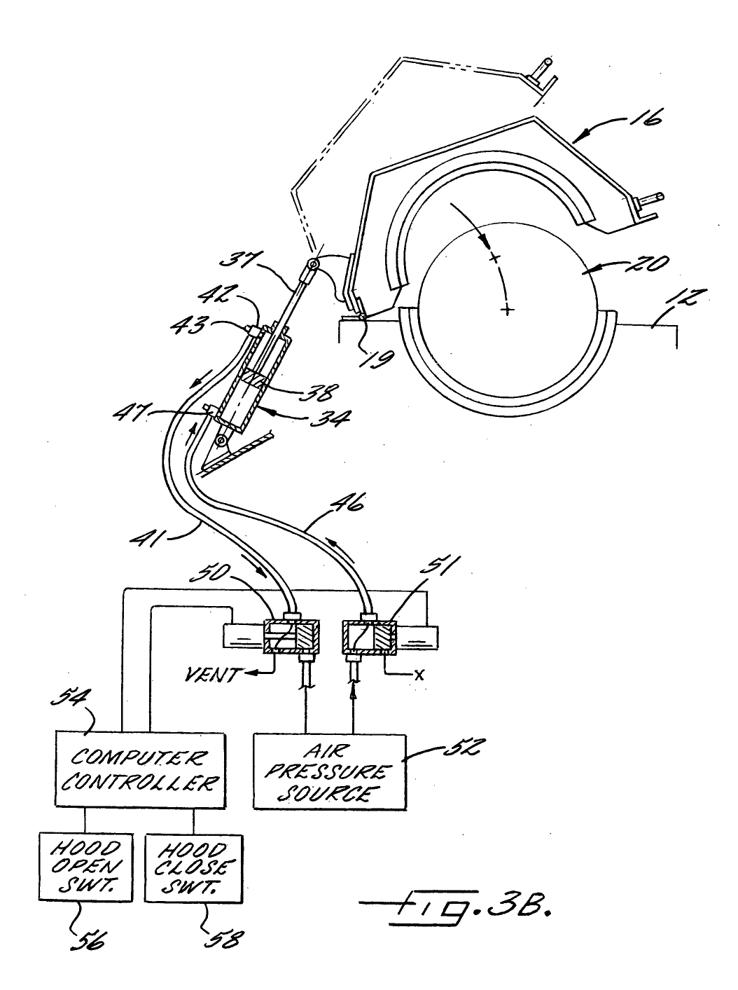

The apparatus comprises a frame which defines a box-like cabinet 12 which includes a pair of front doors 14, and a rear side 15. A hood 16 is pivotally mounted to the top of the cabinet and so as to be pivotable between a closed position (shown in solid lines in FIGS. 2 and 3C) and an open position (shown in broken lines in FIG. 2 and in FIG. 3A). Also, the upper edge of the cabinet 12 supports a pair of bearing blocks 17 (only one being seen in FIG. 1) which rotatably mount a central shaft 18 which defines a horizontal central axis. The hood 16 is mounted for pivotal movement about an axis 19 which is parallel to and spaced rearwardly from the central axis.

A cracking assembly in the form of a turret 20 is fixedly mounted to the shaft 18 so as to be rotatable with the shaft about the central axis. The turret 20 comprises a plurality of elongate cracking units 22 which are circularly arranged about the shaft 18 and supported by radially disposed plates (not shown). There are sixteen cracking units 22 in the illustrated embodiment and the units extend generally parallel to each other and to the central axis.

The cracking units 22 each define an opening for receiving the nuts, and the openings of the units are aligned with an annular opening in the periphery of the turret as best seen in FIG. 2. The structure and function of the cracking units and annular opening are otherwise fully disclosed in the prior patents listed above and which are incorporated by reference.

The apparatus of the present invention further includes means for advancing and delivering a plurality of nuts individually in succession along a path of travel to the rotating turret 20. This nut delivering means includes a hopper 26 for storing a relatively large quantity of nuts to be cracked, and which is fixed to the rear side 15 of the cabinet 12. An endless feed conveyor 28 is provided which includes a feed chain which extends through the hopper and conveys the nuts to a delivery point adjacent the bottom dead center position of the turret 20, all as further described in the prior patents which are incorporated by reference.

The turret 20 is rotatably driven by a motor and chain drive 30 (FIG. 2) and operates so that each cracking unit 22 picks up a nut from the conveyor 28 at the bottom dead center position of the turret. With continued rotation of the turret, the nut is stressed at about the 11 o'clock position of the turret when viewed as seen in FIG. 3 and with the turret rotating in the counterclockwise direction. Immediately thereafter, the nut is cracked, and the cracked nut falls into a delivery chute 32 which exits on the side of the cabinet.

In accordance with the present invention, a pneumatic system is provided for selectively pivoting the hood 16 between the open and closed positions about a pivotal axis 19. This pneumatic system includes a pneumatic cylinder 34 which has a lower end 35 connected to a bottom plate 36 of the hopper 26 of the apparatus, and a piston rod 37 which is connected to a piston 38 slideably mounted within the cylinder and to the hood at a point offset from the pivotal axis 19. As will be apparent from FIGS. 3A-3C, movement of the piston 38 causes the hood 16 to pivot between its open and closed positions.

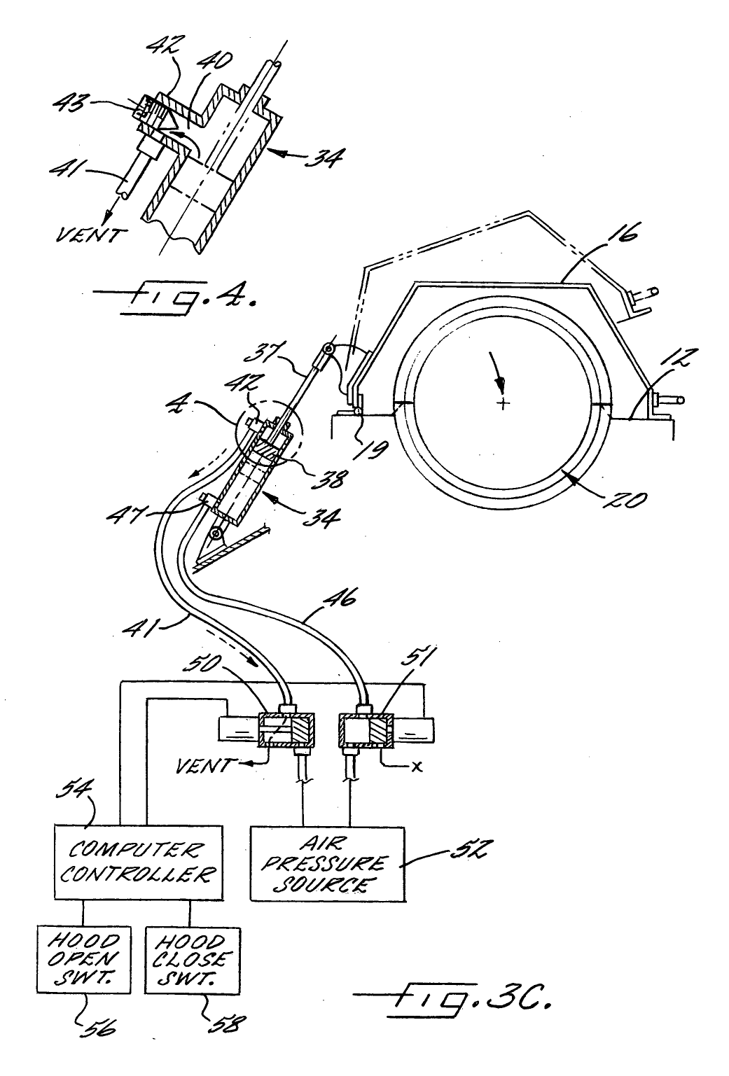

The pneumatic cylinder 34 includes a first port 40 located above the piston, and which is connected to an air delivery line 41 via a bleed valve 42. As seen in FIG. 4, the bleed valve 42 includes a threaded plug 43 by which the area of the air passage through the valve can be adjusted. Also, the bleed valve 42 preferably is of the type which permits the free flow of air in the delivery direction into the cylinder 34 while restricting the flow to an extent determined by the position of the threaded plug 43 in the opposite or venting direction. Such a bleed valve is sold by Legris under Model No. 7015-56-14.

A second port 45 is located in the cylinder 34 below the piston 38, and which is connected to an air delivery line 46 via a bleed valve 47. The bleed-valve 47 corresponds to the structure of the bleed valve 42.

The lines 41 and 46 are respectively connected to two control valves 50, 51 as schematically illustrated in FIGS. 3A-3C, and each control valve 50, 51 is connected to a source 52 of pressurized air via a regulator (not shown). Each valve 50, 51 has a solenoid which is controlled by a programmed computer controller 54, and when energized by a signal from the computer controller 54, the valve 50, 51 moves to an open position which permits free passage of the pressurized air to the associated line 41 and 46, and when de-energized, the valve moves to a venting position.

The operating sequence of the hood pivoting system is controlled by the programmed computer controller 54, which includes a Hood Open switch 56 and a Hood Close switch 58. The operating sequence for both opening and closing the hood are set forth in the following:

The Hood Lifting Sequence

When the hood 16 is in the closed position as seen in solid lines in FIGS. 2 and 3C, which is normally the case when the machine is operating, the valves 50, 51 are normally de-energized and thus both lines are vented to the atmosphere. Thus there is no pressure on either side of the piston 38 in the pneumatic cylinder 34. To lift the hood, the Hood Open switch 56 is pressed which causes the control valve 50 to be energized to the position shown in FIG. 3A and so as to direct the pressurized air into the line 41, through the bleed valve 42, and into the cylinder 34 above the piston 38. The resulting pressure causes the piston rod 37 to move downwardly. The valve 51 remains de-energized and open for venting the line 46, and the bleed valve 47 below the piston 38 serves to control the rate of flow through the vent line 46. Thus the rate of downward movement of the piston 38 is controlled as is the upward pivotal movement of the hood 16. This rate of upward pivotal movement can be easily adjusted by turning the threaded plug 43 of the bleed valve 47 to either increase or decrease the size of the vent opening.

The pressure in the line 41 is maintained while the hood 16 is in its open position and until the Hood Close switch 58 is pressed. While the pressure is maintained in the line 41, the resulting pressure above the piston 38 prevents the hood from inadvertently falling during maintenance procedures which require the hood to be open.

The Hood Lowering Sequence

Upon pressing the Hood Close switch 58, the valve 50 is momentarily energized by the computer controller 54, such as for about 1.5 seconds, to hold the position shown in FIG. 3A and permit the pressurized air to continue to enter the line 41 and thereby insure that the cylinder is fully charged above the piston before closing movement begins. This function is redundant in normal operation since as noted above, the valve 50 is already in the energized position and it continues to deliver pressurized air to the air line 41 until the Hood Close switch 58 is pressed. However, if the hood 16 has been inadvertently manually raised from the closed to the open position, there will be little pressure above the piston 38 and the hood could rapidly fall to the closed position and possibly injure the operator. The fact that the controller 54 is programmed to initially pressurize the space above the piston, before the valve 51 is energized to start the downward movement of the hood, thus serves to insure that such a rapid closure will not occur, even when the hood has been manually lifted to the open position.

After the momentary delay, the valve 50 is then de-energized so that it shifts to its venting position, and the valve 51 is moved to its energized position as shown in FIG. 3B, such that the air is directed into the line 46 and into the cylinder 34 below the piston 38. At the same time, the charge of air above the piston is vented through the bleed valve 42, at a rate controlled by the setting of the threaded plug 43.

Preferably, the valve 51 is held in the energized position for a short period of time, such as about 8 seconds, and so that the hood 16 is caused to close to about two-thirds of its travel. After reaching that point, the air line valve 51 is de-energized by the controller 54, which allows the hood to continue to close due to gravity, with the charge of air above the piston 38 venting at a controlled rate through the bleed off valve 42. This sequence eliminates the possibility that the operator's hand could be caught in the “pinch point” along the forward edge of the hood, and with the forward edge being biased downwardly by pressurized air below the piston, as noted above.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A high production nutcracking apparatus, comprising
a hopper for storing a relatively large quantity of nuts to be cracked,
an endless conveyor extending through the hopper for serially delivering the nuts from the hopper to a cracking assembly which cracks the serially delivered nuts at a cracking location,
said cracking assembly comprising a turret mounted on a machine frame for rotation about a horizontal central axis, with the turret mounting a plurality of cracking units which are uniformly spaced about the periphery of the turret,
said cracking units being configured so that upon rotation of the turret about the central axis, the cracking units each pick up a nut from the endless conveyor at a nut pick up point and convey it to the cracking location where it is cracked,
a hood pivotally mounted to the machine frame for pivotal movement about a horizontal axis which is parallel to said central axis of said turret and for movement between a closed position covering the turret and an open position which allows the machine operator access to the turret,
a pneumatic system for selectively pivoting the hood between the open and closed positions and including
a) a pneumatic cylinder connected between the machine frame and the hood and having an internal piston which is axially moveable in the cylinder, and with the piston being connected to a piston rod which is connected to one of the machine frame and the hood,
b) a pressurized air source comprising a first air line leading to a first port in the pneumatic cylinder on one side of the piston and a second air line leading to a second port in the pneumatic cylinder on the other side of the piston,
c) a first adjustable bleed valve disposed in the first air line and a second adjustable bleed valve disposed in the second air line,
d) control valve means for selectively introducing pressurized air into the first air line while venting the second air line through the second bleed valve, or into the second air line while venting the first air line through the first bleed valve.

2. The nutcracking apparatus of claim 1 wherein the control valve means comprises a computer controller which includes a hood close switch which when pressed momentarily introduces pressurized air into the first air line which biases the piston in the direction to open the hood and then introduces pressurized air into the second air line which moves the piston in the hood closing direction.

3. The nutcracking apparatus of claim 2 wherein the computer controller is programmed such that the step of introducing pressurized air into the second air line is conducted for a time period wherein the hood is partially closed, and after said time period the delivery of air to the second air line is terminated which allows the hood to continue to close due to gravity, with air venting at a controlled rate through the first bleed valve.

4. The nutcracking apparatus of claim 1 wherein the control valve means comprises a computer controller which includes a hood close switch which when pressed introduces pressurized air into the second air line while permitting air to vent at a controlled rate through the first bleed valve and such that the piston moves in the hood closing direction, and after the hood has moved a portion of the distance to the closed position discontinues the introduction of pressurized air into the second air line which allows the hood to continue to close due to gravity, with air continuing to vent at a controlled rate through the first bleed valve.

5. The nutcracking apparatus of claim 1 wherein the control valve means comprises an air pressure source, a first valve connected between the air pressure source and said first air line, a second valve connected between the air pressure source and the second air line, with the first and second valves each being movable between an air venting position and an air delivery position, and a computer controller for selectively controlling the positions of the first and second valves and so that when energized the valves move to the air delivery position and when de-energized the valves move to the venting position.

6. The nutcracking apparatus of claim 5 wherein the computer controller includes a hood close switch, and the controller is programmed such that upon the hood close switch being pressed one of the first and second valves is caused to be energized while the other valve is de-energized to cause the piston to move in the hood closing direction for a portion of the distance to the closed position and then de-energizing the one valve while the other valve remains de-energized so that the hood is free to move the remaining distance to its closed position by gravity.

7. A process for opening and closing a hood on a high speed nutcracking apparatus, with the hood being pivotally mounted on an upper edge of the frame of the apparatus for movement between closed and open positions and which has a pneumatic cylinder interconnected between the hood and the machine frame, comprising the steps of
with the cover in the closed position, pressing a hood open switch which serves to direct pressurized air into one end of the pneumatic cylinder while bleeding air from the other end of the cylinder at a controllable rate, to cause the hood to pivot to its open position at a controlled rate, then
pressing a hood close switch which serves to direct pressurized air into the other end of the pneumatic cylinder while bleeding air from said one end of the cylinder at a controllable rate to cause the hood to pivot toward its closed position at a controlled rate.

8. The process of claim 7 wherein the step of directing pressurized air into the other end of the pneumatic cylinder is conducted only for a period of time to cause the hood to pivot a portion of the distance to its closed position, after which the air supply to other end of the pneumatic cylinder is terminated and while bleeding air from said one end of the cylinder is permitted to continue so that the hood continues its movement to its closed position only under the force of gravity.

9. A process for opening and closing a hood on a high speed nutcracking apparatus, with the hood being pivotally mounted on an upper edge of the frame of the apparatus for movement between closed and open positions and which has a pneumatic cylinder interconnected between the hood and the machine frame, comprising the steps of
with the cover in the closed position, pressing a hood open switch which serves to direct pressurized air into one end of the pneumatic cylinder while bleeding air from the other end of the cylinder at a controllable rate, to cause the hood to pivot to its open position at a controlled rate, then
pressing a hood close switch which serves to
a) direct pressurized air into said one end of the pneumatic cylinder for a limited time period and then
b) direct pressurized air into the other end of the pneumatic cylinder while bleeding air from said one end of the cylinder to cause the hood to pivot toward its closed position at a controlled rate.

10. The process of claim 9 wherein the step of directing pressurized air into the other end of the pneumatic cylinder is conducted only for a period of time to cause the hood to pivot a portion of the distance to its closed position, after which the air supply to other end of the pneumatic cylinder is terminated and while bleeding air from said one end of the cylinder is permitted to continue so that the hood continues its movement to its closed position only under the force of gravity.
